(19) United States
(12) Patent Application Publication
(10) Pub. No.: US 2011/0057053 A1
(43) Pub. Date: Mar. 10, 2011

(54) AROMA DIFFUSER

(75) Inventors: Hidekatsu Kobayashi, Kawasaki (JP); Masamichi Watanabe, Kawasaki (JP); Ryo Hattori, Kawasaki (JP); Shoh Tsuchiya, Gotenba (JP); Nariyasu Hayakawa, Kawasaki (JP); Koichi Kasai, Kawasaki (JP); Yasuhiro Ite, Kawasaki (JP); Satoshi Watanabe, Kawasaki (JP)

(73) Assignee: FUJITSU LIMITED, Kawasaki-shi (JP)

(21) Appl. No.: 12/878,013

(22) Filed: Sep. 8, 2010

(30) Foreign Application Priority Data
Sep. 9, 2009 (JP) 2009-208315

(51) Int. Cl. B05B 1/24

(52) U.S. Cl. 239/135

(57) ABSTRACT

An aroma diffuser includes a housing to include an accommodating part that accommodates at least an aromatic chip, and a lid to be attached to the housing detachably and to close the accommodating part. The aromatic chip is provided for the lid.

### CROSS-REFERENCE TO RELATED APPLICATION

This application is based upon and claims the benefit of priority of the prior Japanese Patent Application No. 2009-208315, filed on Sep. 9, 2009, the entire contents of which are incorporated herein by reference.

### FIELD

Embodiments discussed herein are related to equipment to diffuse an aroma from a device such as a cellular phone.

### BACKGROUND

A device, such as a cellular phone and a camera, given a function of diffusing an aroma is known. The function is achieved by including an aromatic.

Concerning the function of diffusing an aroma, it is known to place an aromatic in an antenna assembly structure and emit an aroma from an aroma emitting port provided in the antenna assembly structure (for example, Japanese Laid-open Patent Publication No. 2002-76734).

It is also known to provide a space for placing an aromatic substance in a portable terminal device and emit the fragrance from the aromatic substance placed in the space for placing an aromatic substance (for example, Japanese Laid-open Patent Publication No. 2004-254026).

### SUMMARY

The aroma diffuser of the present disclosure includes a housing and a lid. The housing includes an accommodating part that accommodates at least an aromatic chip. The lid is attached to the housing detachably and closes the accommodating part. The aromatic chip is provided for the lid.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

Other objects, features and advantages of the embodiments of the invention are more clearly understood by referring to the attached drawings and each of the embodiments.

### BRIEF DESCRIPTION OF DRAWINGS

FIG. 1 depicts an example of an aroma diffuser according to a first embodiment;

FIG. 2 depicts a cellular phone viewed from its back according to a second embodiment;

FIG. 3 is a perspective view of the cellular phone, a rear cover over which is removed.

FIG. 4 is a perspective view depicting the rear cover;

FIG. 5 is a perspective view depicting attachment and detachment of a battery pack;

FIG. 6 is a perspective view depicting an accommodating part of the rear cover;

FIG. 7 is a sectional view of FIG. 6 along the line VII-VII;

FIG. 8 is a sectional view of FIG. 6 along the line VIII-VIII;

FIG. 9 depicts the rear cover viewed from its back;

FIG. 10 is a perspective view depicting a fragrance cap;

FIG. 11 is a perspective view depicting the cap viewed from its back;

FIG. 12 is a perspective view depicting the cap viewed from its back without a fragrance chip;

FIG. 13 is a sectional view of FIG. 12 along the line XIII-XIII;

FIG. 14 is a sectional view of FIG. 12 along the line XIV-XIV;

FIG. 15 is a perspective view depicting the fragrance chip;

FIG. 16 is a sectional view of FIG. 15 along the line XVI-XVI;

FIG. 17 is a sectional view of FIG. 15 along the line XVII-XVII;

FIG. 18 is a sectional view of FIG. 2 along the line XVIII-XVIII;

FIG. 19 is a sectional view of FIG. 2 along the line XIX-XIX;

FIG. 20 is an enlarged sectional view of FIG. 18 at the part holding the fragrance chip;

FIG. 21 is an enlarged sectional view of FIG. 19 at the part holding the fragrance chip;

FIG. 22 depicts the cap being removed;

FIG. 23 depicts an example of impregnation of the fragrance chip with the fragrance;

FIG. 24 depicts another example of the impregnation of the fragrance chip with the fragrance;

FIG. 25 is a flowchart depicting a manufacturing process;

FIG. 26 depicts exchange of the rear cover;

FIG. 27 depicts washing of the chip;

FIG. 28 depicts washing of the chip on the cap;

FIG. 29 depicts a cellular phone viewed from its back according to a third embodiment;

FIG. 30 is a sectional view of FIG. 29 along the line XXX-XXX;

FIG. 31 is a sectional view of FIG. 29 along the line XXXI-XXXI;

FIG. 32 depicts an example of modification on the accommodating part;

FIG. 33 depicts another example of modification on the accommodating part;

FIG. 34 depicts a PC according to other embodiments;

FIG. 35 depicts exchange of a rear cover of the PC; and

FIG. 36 depicts a PDA according to the other embodiments.

### DESCRIPTION OF EMBODIMENTS

It causes restriction of exchange of an aroma to load a dedicated aromatic into a device, or to use a dedicated attachment for loading an aromatic. If the part storing an aromatic is sealed, there rises a problem that when an aroma is exchanged, an aroma before the exchange may not be removed sufficiently.

### First Embodiment

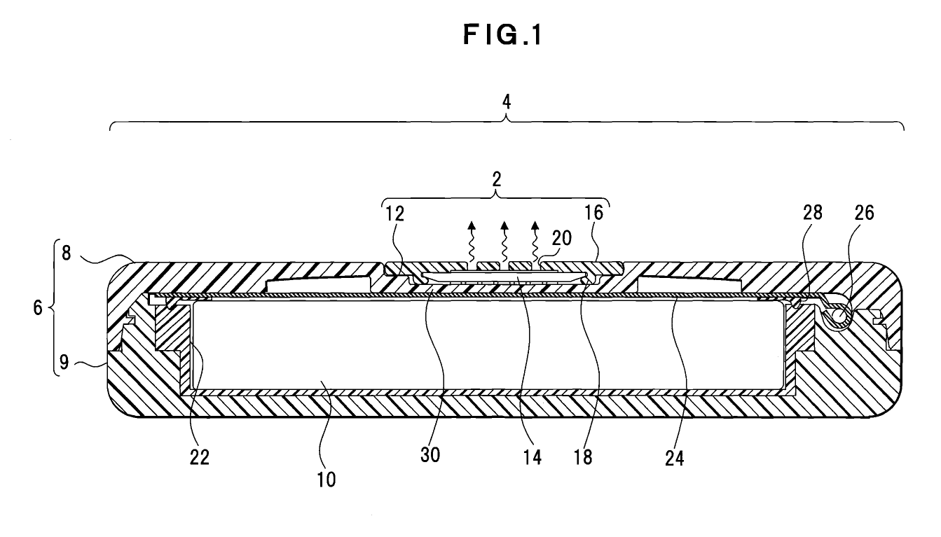

A first embodiment will now be described with reference to FIG. 1. FIG. 1 is a sectional view depicting an example of an aroma diffuser. A structure depicted in FIG. 1 is an example, and thus the present invention is not limited to such a structure.

This aroma diffuser is an example. A housing may include an accommodating part that accommodates at least an aromatic chip, and a lid that closes the accommodating part may be attached to the housing detachably. The aromatic chip may be provided for the lid.

An aroma diffuser unit 2 is an example of the aroma diffuser of the present disclosure and is placed on a device 4 as depicted in FIG. 1. The device 4 is, for example, a portable terminal device such as a cellular phone and a digital camera.

A cover 8 and a main body 9 are provided for a housing 6 of the device 4. A recess 12 is formed in the outer surface of the cover 8. The recess 12 is an example of an accommodating part accommodating at least a fragrance chip (hereinafter “chip”) 14. The chip 14 is an example of an aromatic chip and is made by a chip member impregnated with an aromatic. An aromatic may be any of a fragrance, perfume, eau de Cologne or toilet water. A deodorant may also be used.

In this case, a lid 16 is placed attachably and detachably over the recess 12. The chip 14 is provided for the inner surface of the lid 16 attachably and detachably by being held by a plurality of holders 18 that are provided for the lid 16. A single or a plurality of diffuser holes 20 are formed through the part holding the chip 14 on the lid 16.

A case 22 accommodating a component 10 is formed in the main body 9. The case 22 is formed within the main body 9 and is opened and closed by an inside cover 24 that is placed on the inner side of the cover 8. The inside cover 24 is attached to the main body 9 openably and closably by a hinge 26. A packing 28 is got intervening between the inside cover 24 and the case 22 and thus, waterproof construction of the case 22 is achieved. The hinge 26 is an example of an opening and closing mechanism for opening and closing the inside cover 24. A screw which is a fixing means may be used for opening and closing (attaching and detaching) the inside cover 24.

A convex 30 is provided for the inner surface of the cover 8. The convex 30 contacts the inside cover 24. That is, the cover 8 attached to the main body 9 causes the inside cover 24 to be pressed and thus the above described waterproof construction is maintained. In the embodiment, the convex 30 is formed for providing the recess 12 for the outer surface of the cover 8. That is, the convex 30 and the recess 12 are both sides of the cover 8 as sandwiching the thick-wall part of the cover 8.

According to such a structure, an aromatic such as a fragrance, with which the chip 14 is impregnated, is vaporized and diffused from the diffuser holes 20 on the lid 16, and an aroma thereof can be wafted.

If the component 10 is a heat generating component such as a battery pack, the heat therefrom is transmitted from the inside cover 24 to the cover 8. The transmitted heat is able to promote the vaporization of a fragrance.

Since the chip 14 is made by a chip member impregnated with a fragrance, washing of the chip member enables exchange with a different fragrance and thus enables a different aroma to be diffused. In this case, a desired aroma may be diffused by selecting a different aroma through exchange with the cover 8 of the other chip 14, exchange with the lid 16 of the other chip 14 or exchange with the chip 14 impregnated with a different fragrance.

The chip 14 and the lid 16 are placed outside the cover 8 of the device 4. There is no inconvenience that a fragrance penetrates the waterproof construction of the device 4 since the chip 14 is placed outside the waterproof construction of the device 4, that is, outside a waterproof area.

### Second Embodiment

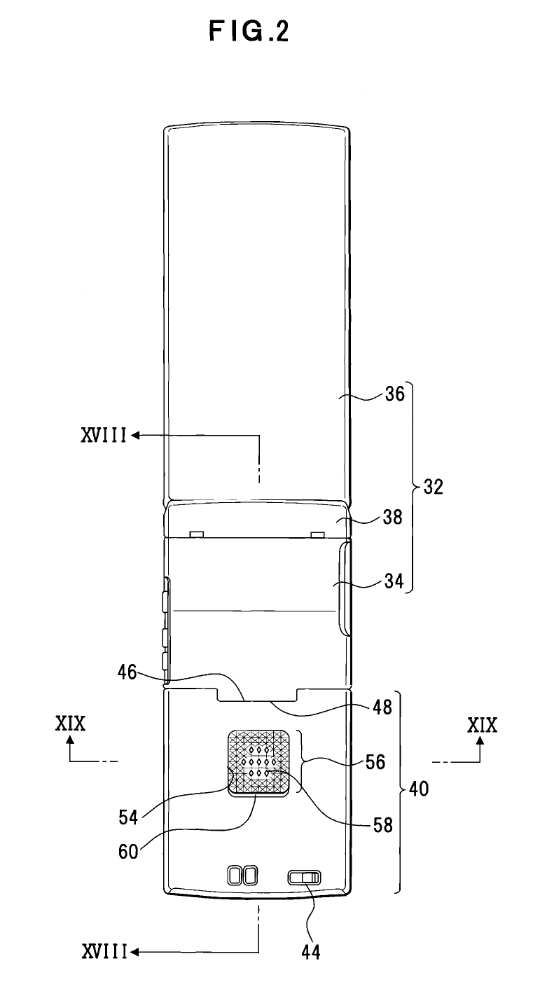

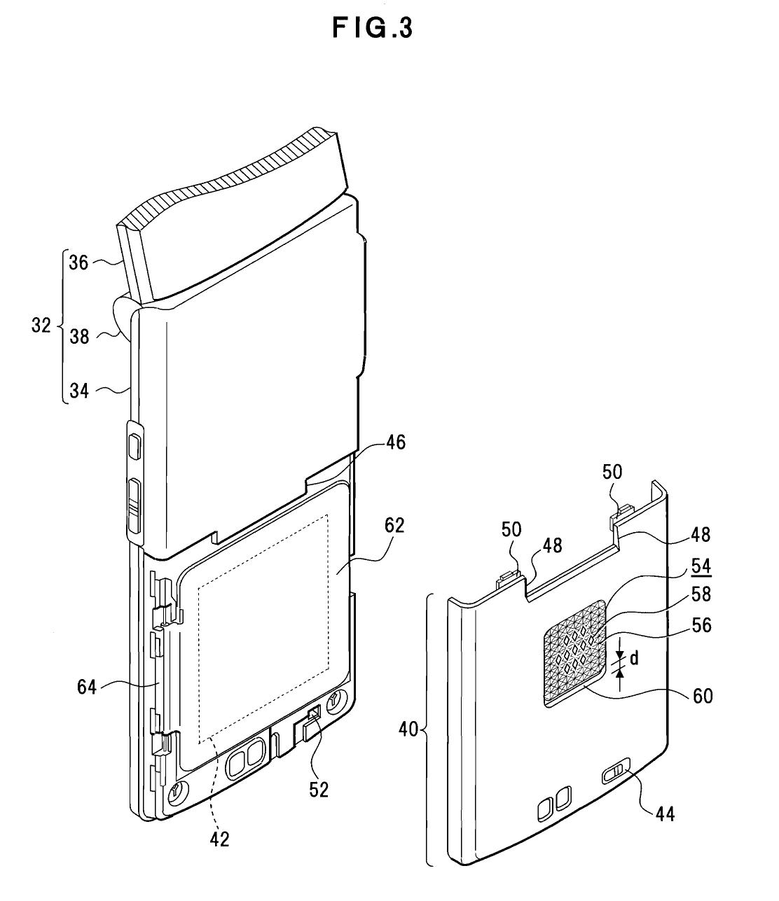

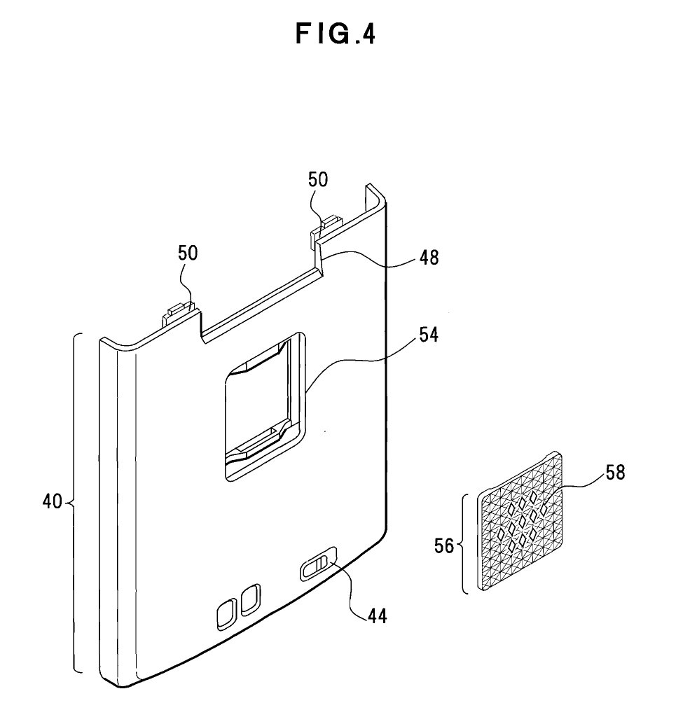

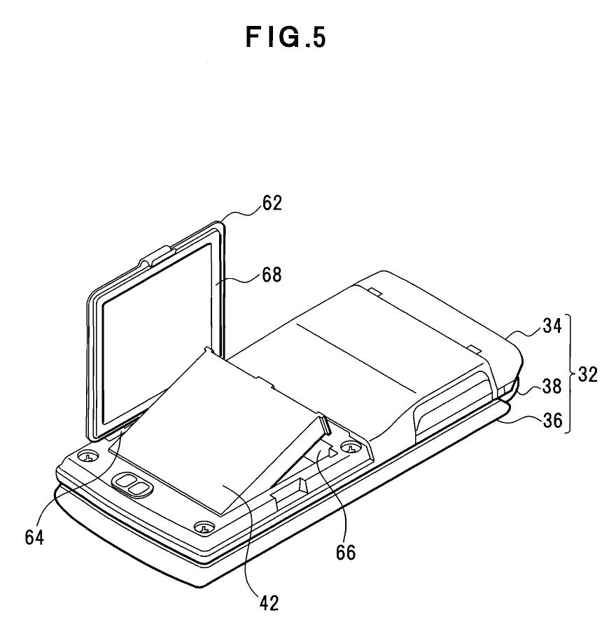

A second embodiment will now be described with reference to FIGS. 2, 3, 4 and 5. FIG. 2 depicts a cellular phone viewed from its back according to the second embodiment, FIG. 3 is a perspective view of the cellular phone, a rear cover over which is removed, FIG. 4 is a perspective view depicting the rear cover, and FIG. 5 is a perspective view depicting attachment and detachment of a battery pack. Each structure depicted in FIGS. 2 to 5 is an example, and thus the present invention is not limited to such structures.

This cellular phone is an example of an aroma diffuser (aroma diffuser unit 2). A housing may include an accommodating part that accommodates at least an aromatic chip and a lid that closes the accommodating part attachably and detachably. The aromatic chip may be held over the lid attachably and detachably.

A cellular phone 32 is an example of the aroma diffuser of the present disclosure. The cellular phone 32 is an example of a portable device which is carried, and has a first housing 34 and a second housing 36 as depicted in FIGS. 2, 3 and 4. These housing 34 and housing 36 are linked to each other by a hinge 38, and thus foldable, or openable and closable. The housing 34 is a member corresponding to the above described main body 9 (FIG. 1), and in the embodiment, is a housing of a keyboard which has a plurality of keys on its front side. The housing 36 is a housing of a display which has a display on its front side.

A rear cover 40 is attached to the back of the housing 34 detachably. The rear cover 40 is an example of a back member, is an opening and closing means of the housing 34 for attaching and detaching a battery pack 42 built into the housing 34 (FIG. 5), and corresponds to the above described cover 8 (FIG. 1). The rear cover 40 may be formed by synthetic resin or metal. A locking mechanism 44 is attached to the rear cover 40 for keeping its fixation locked after the housing 34 is fixed.

An engaging protrusion 46 for engaging the housing 34 to the rear cover 40 is formed in the housing 34. An engaging recess 48 for engaging the rear cover 40 with the engaging protrusion 46 is formed in the rear cover 40. The engaging protrusion 46 and the engaging recess 48 are meshed to be engaged with each other. As depicted in FIG. 3, insertion stopping parts 50 are formed at both sides of the engaging recess 48 as a pair of engaging means. An edge of the housing 34 is inserted into each of the insertion stopping parts 50 to be engaged. Such an engaging structure of the housing 34 and the rear cover 40 enables the rear cover 40 to be attached to the housing 34 detachably. A groove 52 is formed in the housing 34. The groove 52 engages the above locking mechanism 44. A pawl of the locking mechanism 44 is meshed with the groove 52, and thus the engagement of the housing 34 and the rear cover 40 is held locked. Thereby, easy separation of the rear cover 40 from the housing 34 is prevented.

A fragrance accommodating part (hereinafter “accommodating part”) 54 is formed in the center of the outer surface of the rear cover 40. The accommodating part 54 is closed by a fragrance cap (hereinafter “cap”) 56. As depicted in FIG. 4, the cap 56 is openable and closable. That is, the accommodating part 54 is opened and closed by the cap 56. The accommodating part 54 corresponds to the above described recess 12 (FIG. 1), and forms space, which is able to accommodate at least a chip 14, therein. The cap 56 is a member corresponding to the above described lid 16 (FIG. 1). A single or a plurality of diffuser holes 58 are formed through the cap 56. The diffuser holes 58 are means diffusing an aroma of the chip 14 that is accommodated by the accommodating part 54. A gap 60 is formed between the accommodating part 54 and the cap 56. The gap 60 is an example of a recess and is used for removing the cap 56 from the accommodating part 54. The width d of the gap 60 may be a width through which a coin or a nail of a person can enter.

To the housing 34 having such rear cover 40, a battery cover 62 is attached by a hinge 64 openably and closably in the interior of the rear cover 40 as depicted in FIG. 5. The battery cover 62 corresponds to the above described inside cover 24 (FIG. 1). The battery cover 62 is a means opening and closing a battery case 66, and is made by, for example, a metal plate. The battery case 66 is a means accommodating the battery pack 42. A waterproof packing 68 is placed in the battery cover 62. The waterproof packing 68 is annular and corresponds to a form of the edge of the battery case 66. The waterproof packing 68 is a means sealing the battery cover 62 and the battery case 66, and constitutes waterproof construction along with the battery cover 62 and the battery case 66.

Backs of Fragrance Accommodating Part 54 and Rear Cover 40

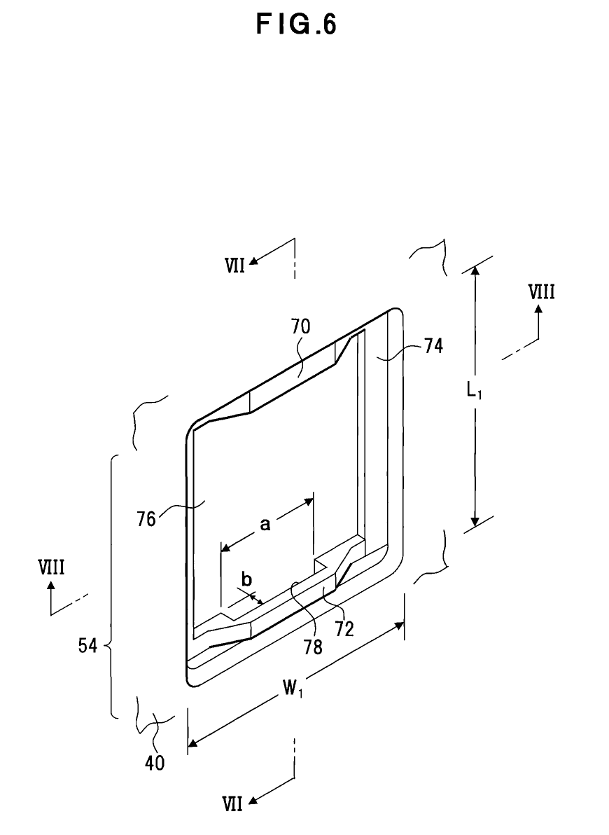

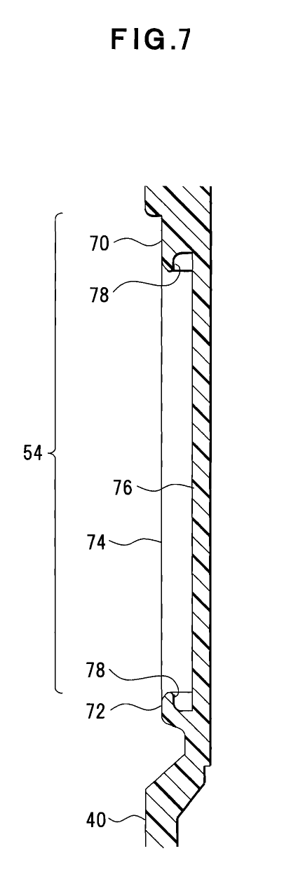

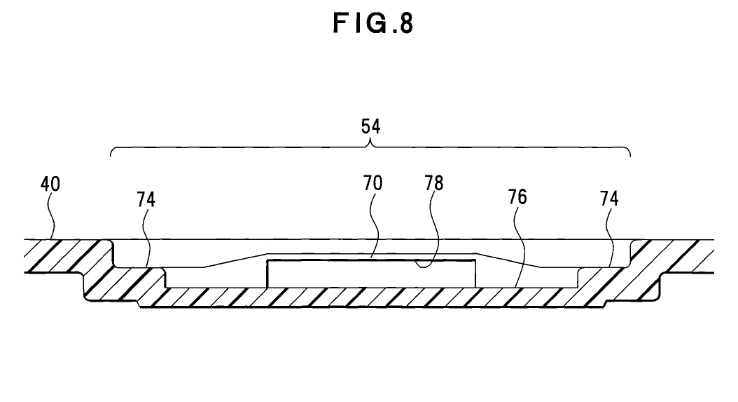

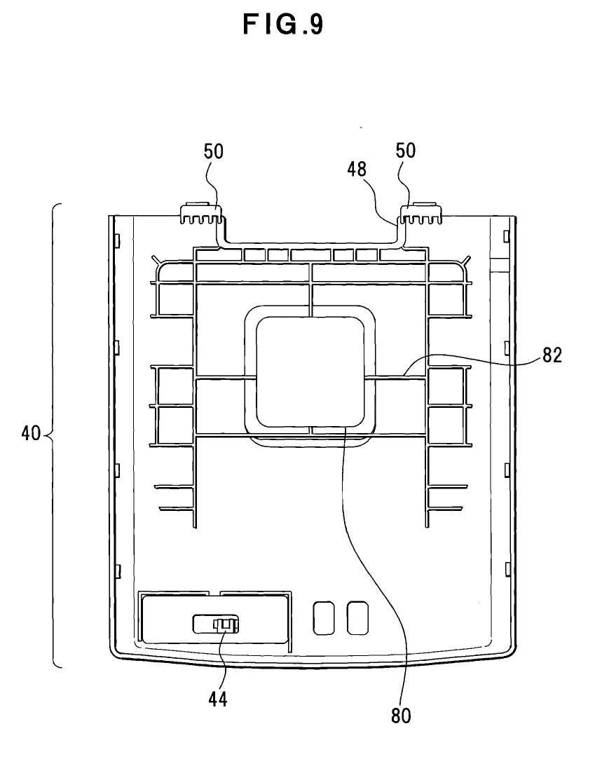

Backs of the accommodating part 54 and the rear cover 40 will now be described with reference to FIGS. 6, 7, 8 and 9. FIG. 6 is a perspective view depicting the accommodating part of the rear cover, FIG. 7 is a sectional view of FIG. 6 along the line VII-VII, FIG. 8 is a sectional view of FIG. 6 along the line VIII-VIII and FIG. 9 depicts the rear cover viewed from its back. Each structure depicted in FIGS. 6 to 9 is an example, and thus the present invention is not limited to such structures. In FIGS. 6 to 9, the same components as those in FIGS. 2 to 5 are denoted by the same reference numerals.

A first and second engaging fixation parts 70 and 72 for attaching the cap 56 detachably and a supporting part 74 that supports the cap 56 are formed inside the accommodating part 54 as depicted in FIGS. 6, 7 and 8. Each of the engaging fixation parts 70 and 72 is, for example, a C-shape protruding from an inner wall surface (or a bottom face) 76 of the accommodating part 54, and has a recess 78. The recess 78 is, for example, a rectangular cylinder shape, and has a width “a” narrower than a lateral width of the accommodating part 54 W₁, and a height “b”. In the embodiment, a longitudinal width of the accommodating part 54 L₁ is set wider than the lateral width W₁ (L₁>W₁). In this case, L₁ may be equal to W₁ or L₁ may be narrower than W₁.

The supporting part 74 is a means protecting the rear cover 40 from falling in the direction of thickness, is formed in a direction crossing the engaging fixation parts 70 and 72, and supports the cap 56 on the same or parallel face of the outer surface of the rear cover 40.

A convex 80 is formed for forming the accommodating part 54 on the back of such rear cover 40 that has the accommodating part 54 as depicted in FIG. 9. A plurality of ribs 82 are formed on the back of the rear cover 40. The ribs 82 reinforce the rear cover 40.

Fragrance Cap 56

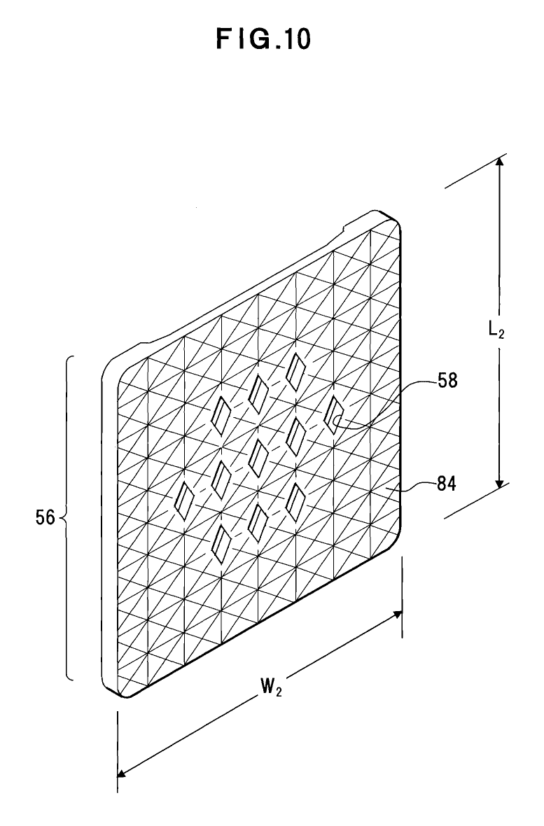

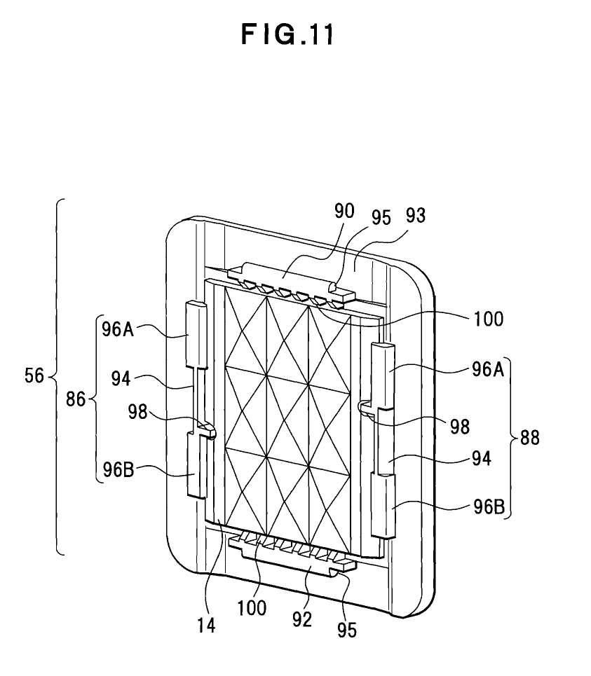

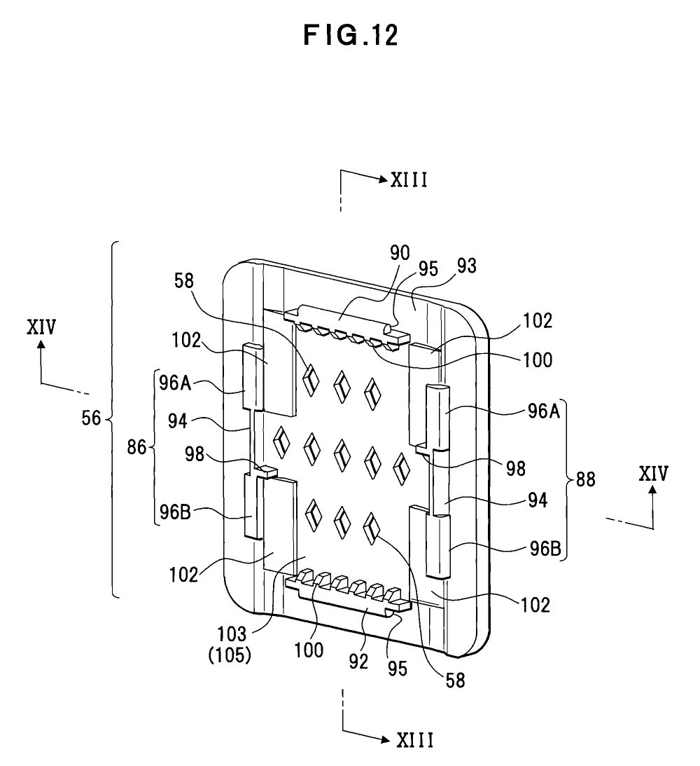

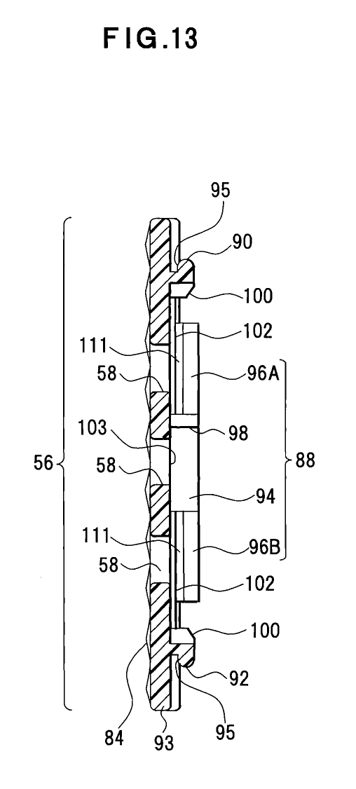

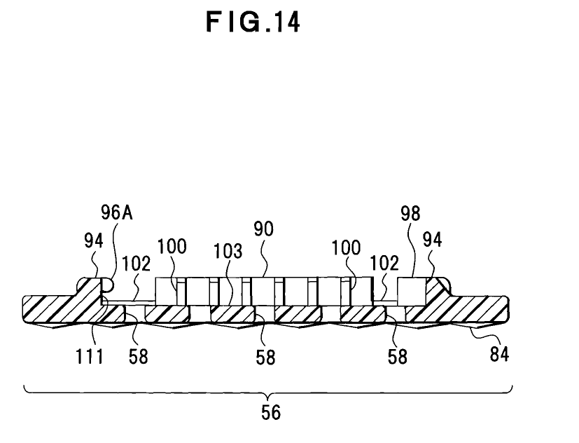

The cap 56 will now be described with reference to FIGS. 10, 11, 12, 13 and 14. FIG. 10 is a perspective view depicting the cap, FIG. 11 is a perspective view depicting the cap viewed from its back, FIG. 12 is a perspective view depicting the cap viewed from its back without a fragrance chip, FIG. 13 is a sectional view of FIG. 12 along the line XIII-XIII, and FIG. 14 is a sectional view of FIG. 12 along the line XIV-XIV. Each structure depicted in FIGS. 10 to 14 is an example, and thus the present invention is not limited to such structures. In FIGS. 10 to 14, the same components as those in FIG. 2 are denoted by the same reference numerals.

The cap 56 is a closing means that closes the accommodating part 54 and also is a holding means for holding the chip 14. The cap 56 maybe made by synthetic resin or metal as well as the rear cover 40. If a lateral width of the cap 56 in the embodiment is W₂ and a longitudinal width thereof is L₂, W₁ is wider than W₂ and L₁ is wider than L₂+d (the gap 60) for the lateral width of the accommodating part 54 W₁ and the longitudinal width thereof L₁. That is, a width of clearance between a shape or size of the accommodating part 54 (FIG. 6) and that of the cap 56, which is attached and detached (FIG. 10), “w” (=W₁−W₂) may be a width enough for the cap 56 to be attached to and detached from the accommodating part 54.

An uneven face 84 is regularly or irregularly formed over the surface of the cap 56 as depicted in FIG. 10. Forming the uneven face 84 enables a surface area of the cap 56 to be enlarged. This enlargement contributes to raising a temperature of the chip 14 that is placed on the back of the cap 56 and enables diffusion of an aroma to be promoted. There is also a function that the uneven face 84 camouflages the diffuser holes 58. In the embodiment, forming the uneven face 84 like a diamond pattern hides the diffuser holes 58 of lozenges.

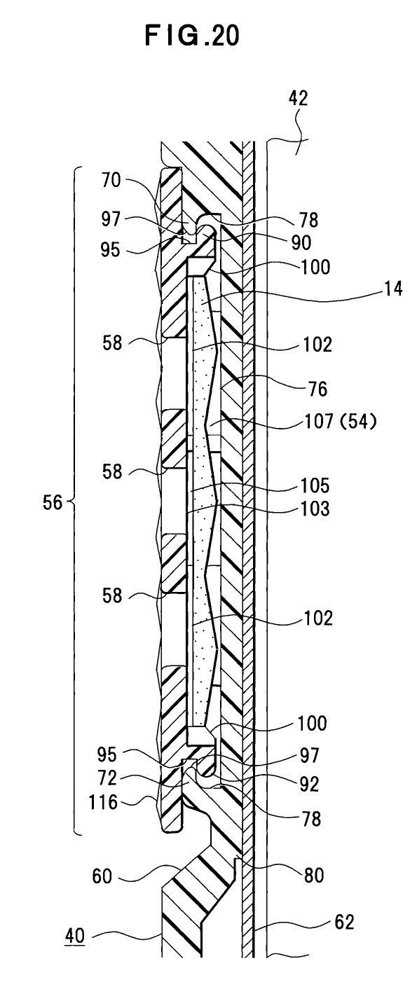

A first and second chip fixation parts 86 and 88 and a first and second engaging protrusions 90 and 92 are provided on the back of the cap 56 as depicted in FIGS. 11, 12, 13 and 14. An engaging recess 95 is formed between each of the engaging protrusions 90 and 92, and a main body 93 of the cap 56. Each of the engaging recesses 95 is a means for engaging each engaging protrusion 97 (FIG. 20) of the engaging fixation parts 70 and 72 of the accommodating part 54. Engaging the engaging recess 95 and the engaging protrusion 97 makes the cap 56 attach to the accommodating part 54 detachably.

Each of the chip fixation parts 86 and 88 is an example of a means positioning and fixing the chip 14, and is placed in the direction of the width of the chip 14, that is, along a side of the chip 14. Each of the chip fixation parts 86 and 88 has a pair of holders 96A and 96B which are formed therein and sandwich a standing wall 94. Positioning protrusions 98 are formed from faces, which are opposite to each other, of the standing walls 94, respectively. While one of the positioning protrusion 98 is from the holder 96B, the other positioning protrusion 98 is from the holder 96A. The positioning protrusions 98 are arranged so as to be reflection symmetry. Each of the holders 96A and 96B is an example of a holding means for the chip 14. The holders 96A and 96B hold the chip 14 by sandwiching the chip 14 between the back of the cap 56 and themselves.

The engaging protrusion 90 is inserted into the recess 78 of the engaging fixation part 70 of the accommodating part 54 (FIG. 20) to be fixed. The engaging protrusion 92 is inserted into the recess 78 of the engaging fixation part 72 of the accommodating part 54 (FIG. 20) to be fixed. Each of the engaging protrusions 90 and 92 is placed at the position where the chip 14 is sandwiched in a direction crossing each of the chip fixation parts 86 and 88. A plurality of supporting protrusions 100 are provided for the back of each of the engaging protrusions 90 and 92. The supporting protrusions 100 support the chip 14.

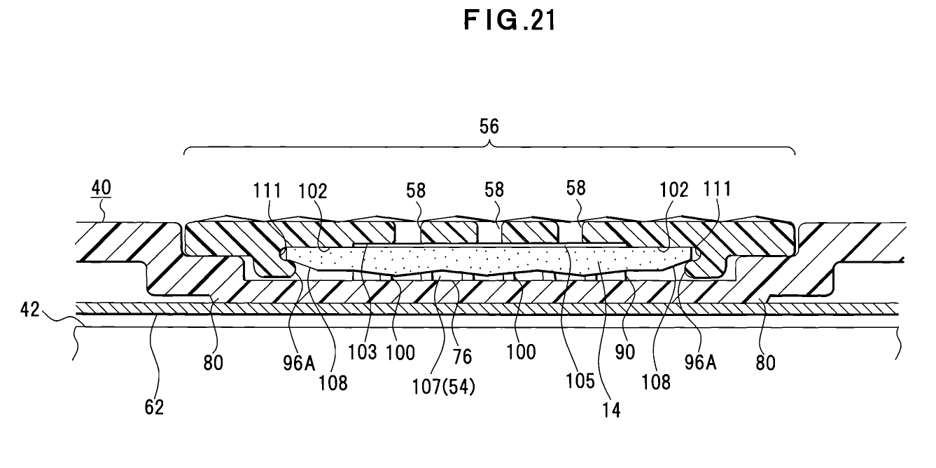

Protrusions 102 are formed on the back of the cap 56. The protrusions 102 are adjacent to the holders 96A and 96B, which are formed on the left and right of the cap 56, respectively, and avoid an area where the diffuser holes 58 are formed. A recess 103 is formed in the gap between each of the protrusions 102. The recess 103 is set for an area where the diffuser holes 58 are formed. The protrusions 102 and the recess 103 are means for forming a space 105 (FIGS. 20 and 21) between the chip 14 and cap 56. The air that accumulates, or is convective, in the space 105 communicates with the diffuser holes 58.

Fragrance Chip 14

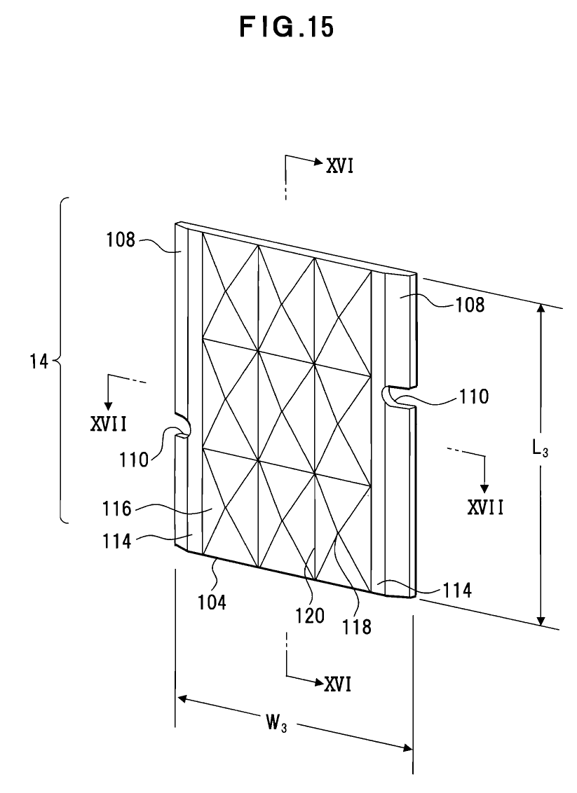

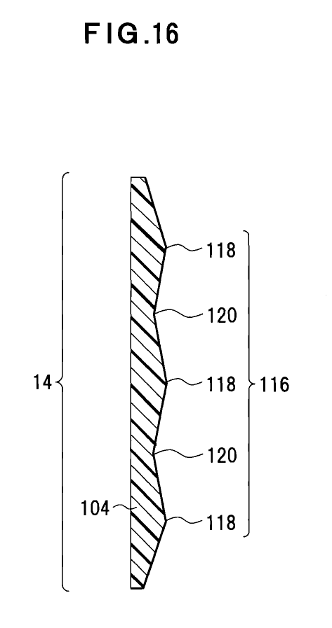

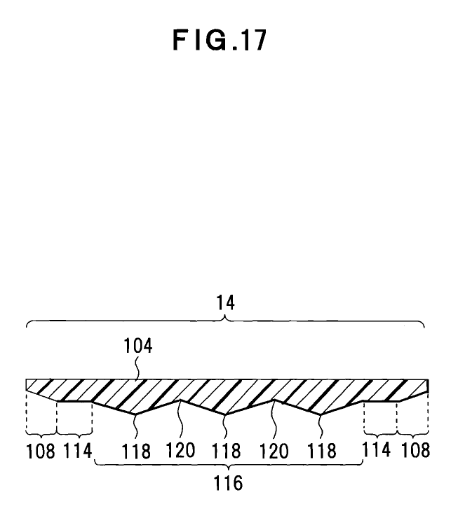

The chip 14 will now be described with reference to FIGS. 15, 16 and 17. FIG. 15 is a perspective view depicting the fragrance chip, FIG. 16 is a sectional view of FIG. 15 along the line XVI-XVI, and FIG. 17 is a sectional view of FIG. 15 along the line XVII-XVII. Each structure depicted in FIGS. 15 to 17 is an example, and thus the present invention is not limited to such structures.

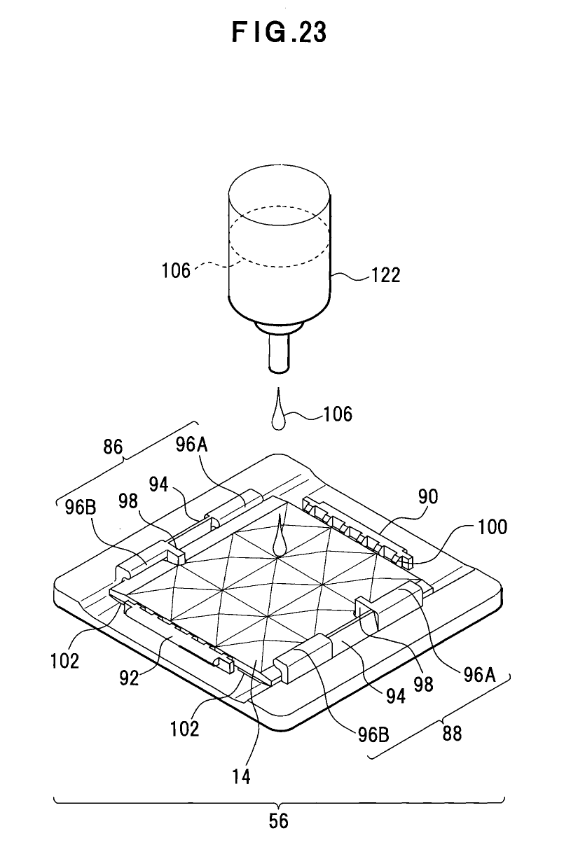

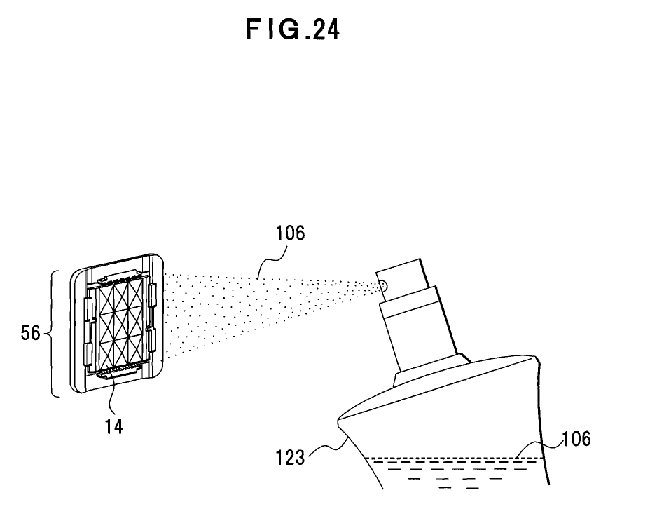

The chip 14 is made by impregnating a chip member 104 with a fragrance 106 (FIG. 23 or 24) as depicted in FIG. 15. The chip member 104 is a rectangle having a lateral width W₃ and a longitudinal width L₃. The lateral width W₃ is slightly narrower than a gap which the chip fixation parts 86 and 88 of the cap 56 are able to fix. The longitudinal width L₃ is slightly narrower than a gap which the engaging protrusions 90 and 92 of the cap 56 are able to support.

A fixation edge 108 and a positioning part 110 are provided for each edge of the chip 14 in a width direction. Each of the fixation edges 108 is inserted into each of the recess 111 (FIGS. 13, 14 and 21) of the holders 96A and 96B of the chip fixation parts 86 and 88 of the cap 56 to be held, and the chip 14 is fixed to the cap 56. Each of the fixation edges 108 is made by an edge side of the chip member 104 being thinned, and has a trapezoidal section.

The positioning parts 110 are positioning means that position the chip 14 at a predetermined position of the cap 56 by engaging themselves with the positioning protrusions 98 of the cap 56. In the embodiment, the positioning parts 110 are constructed by U-shaped notches that are cut out of the fixation edges 108 toward flat surfaces 114.

An uneven face 116 is formed between the flat surfaces 114, on the surface of the chip member 104. In the embodiment, tips 118 of a quadrilateral pyramid is arranged in a plurality of rows and columns as depicted in FIGS. 16 and 17. A V-shaped recess 120 is formed at each edge of the tip 118. Providing such uneven face 116 leads to a larger surface area of the chip 14 than an area determined by the lateral width W₃×the longitudinal width L₃. Enlarging the surface area like the above enlarges an area of the chip 14 touching the air. Thereby, diffusion of the fragrance 106 in the air is promoted.

Part for Accommodating Fragrance Chip, Attachment and Detachment of Cap and Impregnation of Fragrance

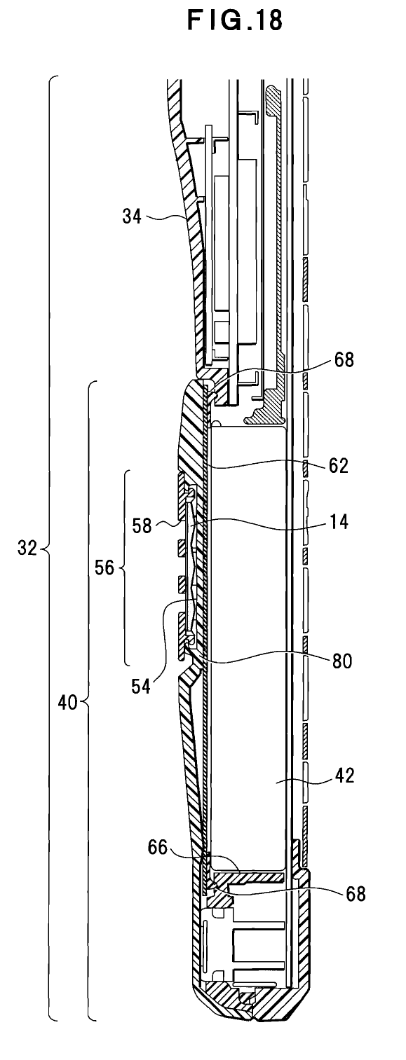

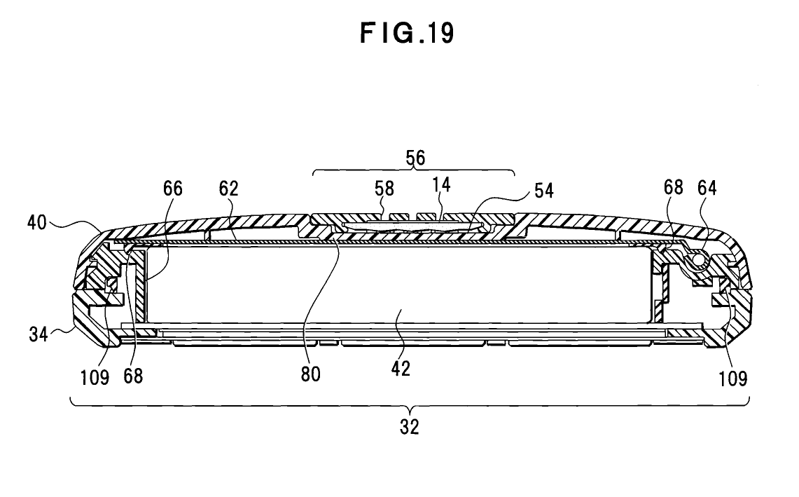

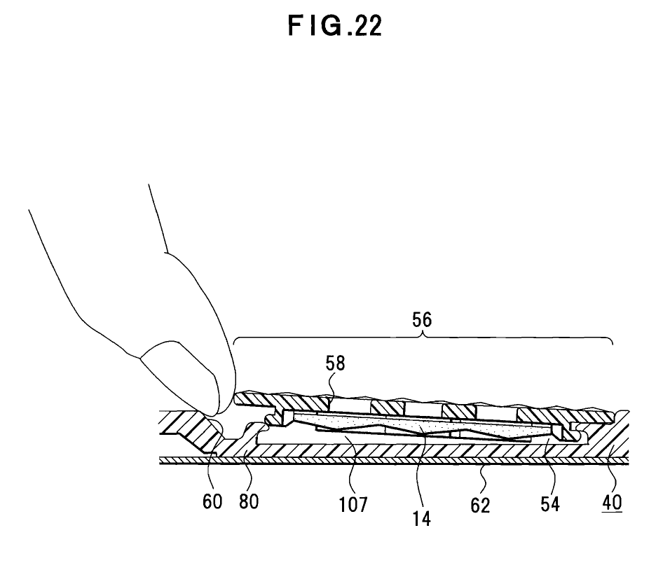

A sectional area of the part for accommodating the fragrance chip will now be described with reference to FIGS. 18, 19, 20, 21, 22, 23 and 24. FIG. 18 is a sectional view of FIG. 2 along the line XVIII-XVIII, FIG. 19 is a sectional view of FIG. 2 along the line XIX-XIX, FIG. 20 is an enlarged sectional view of FIG. 18 at the part holding the fragrance chip, FIG. 21 is an enlarged sectional view of FIG. 19 at the part holding the fragrance chip, FIG. 22 depicts the cap being removed, FIG. 23 depicts an example of impregnation of the fragrance, and FIG. 24 depicts another example of the impregnation of the fragrance. Each structure depicted in FIGS. 18 to 24 is an example, and thus the present invention is not limited to such structures.

The rear cover 40 having the above described chip 14 is placed on the housing 34 of the cellular phone 32 as depicted in FIGS. 18 and 19. The chip 14 is held by the cap 56 that is placed over the accommodating part 54 of the rear cover 40 as depicted in FIGS. 20 and 21. The cap 56 is fixed by inserting the engaging protrusion 90 into the recess 78 of the engaging fixation part 70 and by inserting the engaging protrusion 92 into the recess 78 of the engaging fixation part 72. In this case, each of the engaging protrusions 97 at the accommodating part 54 is inserted into the engaging recess 95 at the cap 56. Around such engaging protrusion 90, fixation is achieved by a plurality of meshing engagements of the engaging protrusion 90 with the recess 78 of the engaging fixation part 70 and the engaging protrusion 97 with the engaging recess 95. Around the engaging protrusion 92, fixation is achieved by a plurality of meshing engagements of the engaging protrusion 92 with the recess 78 of the engaging fixation part 72 and the engaging protrusion 97 with the engaging recess 95. Through such a plurality of engagements, the cap 56 is attachable to and detachable from the accommodating part 54 and is fixed firmly to seal the opening of the accommodating part 54. The chip 14 is held by the cap 56. Thus, if the chip 14 is impregnated with the fragrance 106, the fragrance 106 is diffused from the diffuser holes 56 and an aroma therefrom can be smelled.

In the embodiment, when the cap 56 is placed over the accommodating part 54, a space 107 is secured between the chip 14 on the cap 56 and the inner wall surface 76 of the accommodating part 54 as depicted in FIGS. 20 and 21. The space 107 may be formed by forming the accommodating part 54 deep so that there appears clearance between the chip 14 and the inner wall surface 76. The air is convective or accumulates in the space 107. The air touches the chip 14 enough to promote diffusing an aroma of the fragrance 106 from the chip 14 by volatilization of alcohol.

Since the battery pack 42 is placed on the back of the accommodating part 54, that is, the back of the convex 80 via the battery cover 62, generated heat from the battery pack 42 can be got acting on the chip 14. That is, the convex 80 that protrudes over the back of the accommodating part 54 adheres to the battery pack 62, and the heat of the battery pack 42 is conducted to the convex 80 via the battery cover 62. If the battery cover 62 is a metal plate, good heat conductivity is achieved, and then the heat of the battery pack 42 can be got acting on the chip 14 efficiently. Consequently, heating the chip 14 promotes vaporization of alcohol included in the fragrance 106. Diffusion of the fragrance 106 is also promoted as well as the vaporization.

Even if the chip 14 is impregnated with the fragrance 106, the housing 34 is not impregnated with the fragrance 106. That is, penetration with the fragrance 106 is suppressed because waterproof construction of the battery cover 62 and that of the housing 34 by the packing 109 of the battery case 66 (FIG. 19) are provided. Moreover, the fragrance 106 does not act on the battery pack 42.

When the diffusion of the fragrance 106 is ended, supplement of the fragrance 106 or exchange with the chip 14 may be executed. To remove the cap 56 from the cellular phone 32, the cap 56 may be pulled up from the rear cover 40 by inserting a fingertip or a coin into the gap 60 as depicted in FIG. 22. Thereby, the chip 14 is removable along with the cap 56.

The fragrance 106 that is the same as the fragrance 106 used up already can be supplemented since the chip 14 is held by the cap 56. In this case, the fragrance 106 may be dropped down onto the chip 14 from a container 122 of the fragrance 106 and the chip 14 is impregnated as depicted in FIG. 23, or the fragrance 106 may be sprayed from an atomizer 123 and the chip 14 is impregnated as depicted in FIG. 24.

To attach the cap 56 including the chip 14 where the fragrance 106 is supplemented, as depicted in FIG. 22, the cap 56 may be inserted and put onto the edge opposite to the gap 60 of the accommodating part 54, and may be pressed in the direction opposite to pulling up.

Method of Manufacturing Cellular Phone 32

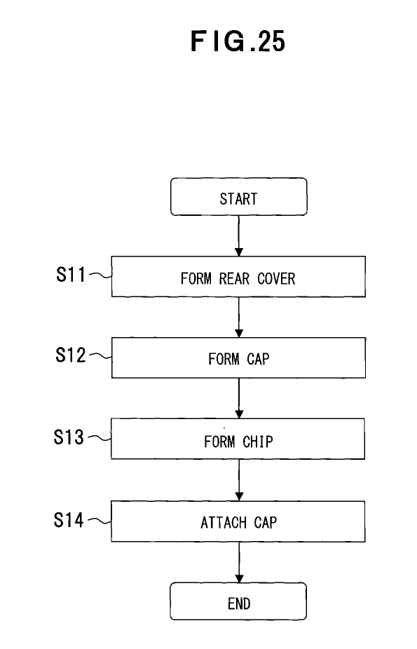

A method of manufacturing the cellular phone will now be described with reference to FIG. 25. FIG. 25 is a flowchart depicting a process of manufacturing the cellular phone. A structure depicted in FIG. 25 is an example, and thus the present invention is not limited to such a structure.

Processing procedure of the manufacturing method is an example of a method of manufacturing the aroma diffuser of the present disclosure. The processing procedure includes a process of forming the rear cover (step S11), a process of forming the cap (step S12), a process of forming the chip (step S13) and a process of attaching the cap where the chip is attached (step S14) as depicted in FIG. 25.

a) Process of Forming Rear Cover (Step S11)

The rear cover 40 that fits the housing 34 of the cellular phone 32, which is an example of a device for diffusing a fragrance, is formed (step S11). The above described accommodating part 54 is formed in the rear cover 40. Such rear cover 40 including the accommodating part 54 is waterproof. The rear cover 40 may be formed in the above described form by being molded from synthetic resin or a metal plate which has resistance to the fragrance 106 (fragrance resistance). Waterproof is effective when the rear cover 40 is washed by water.

Effects from alcohol included in the fragrance 106 is avoidable if crystalline nylon or PP (polypropylene) of corrosion resistance is adopted as the rear cover 40.

b) Process of Forming Cap (Step S12)

Since the cap 56 is a closing means of the accommodating part 54 of the rear cover 40 and also is a fixing and holding means for the chip 14, a structure thereof is as described above. The cap 56 including such a structure is waterproof and may be formed by being molded from synthetic resin or a metal plate which has resistance to the fragrance 106 as well as the rear cover 40. Waterproof is effective when the cap 56 is washed by water.

Effects from alcohol included in the fragrance 106 is also avoidable if crystalline nylon or PP (polypropylene) of corrosion resistance is adopted as the cap 56.

c) Process of Forming Chip (Step S13)

Since the chip 14 is an impregnating means of the fragrance 106, the chip 14 may preferably have resistance to the fragrance 106 and a function of holding the fragrance 106. Porous ceramics may be used as a porous material for the chip member 104. Zirconia may be used as porous ceramics.

d) Process of Attaching Cap where Chip is Attached (Step S14)

Since the cap 56 has the above structure, the chip 14 is attachable easily. The cap 56 having the chip 14 may be attached to the accommodating part 54 of the rear cover 40, and the rear cover 40 may be placed over the housing 34 of the cellular phone 32. Thereby, the cellular phone 32 that is able to diffuse the fragrance 106 is obtained.

Exchange of Rear Cover 40, Cap 56, Fragrance Chip 14 or Fragrance 106

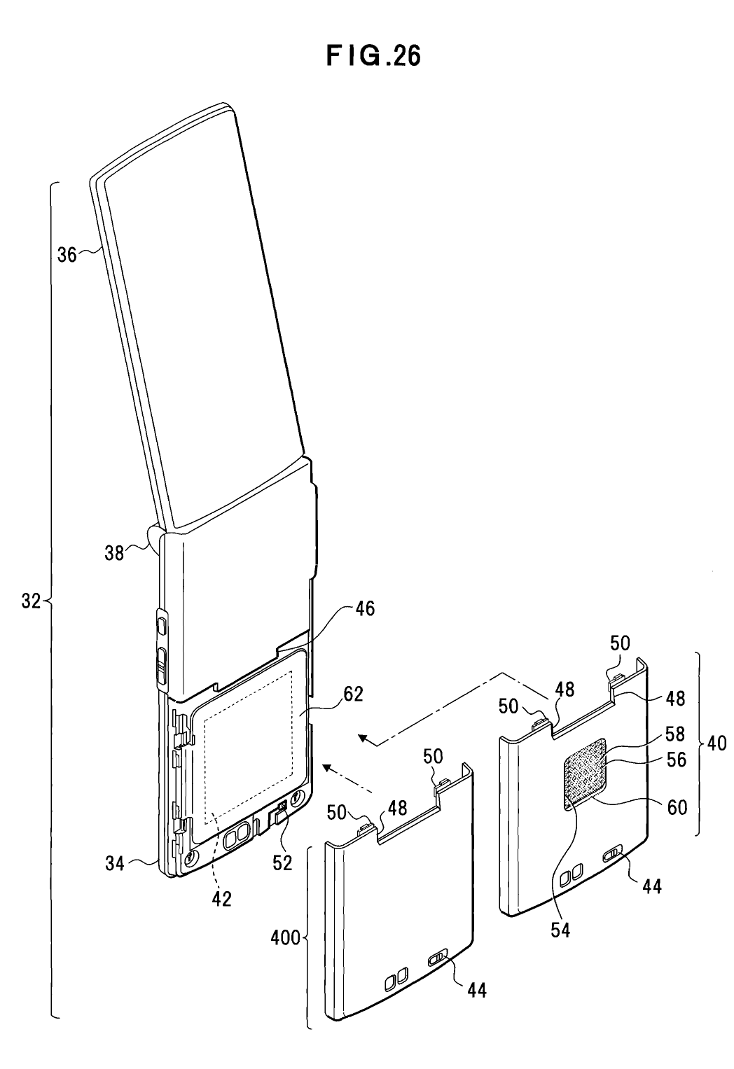

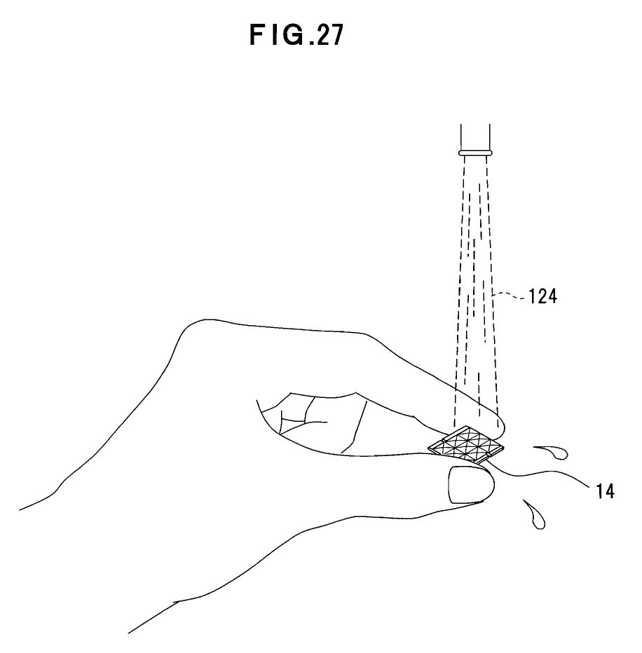

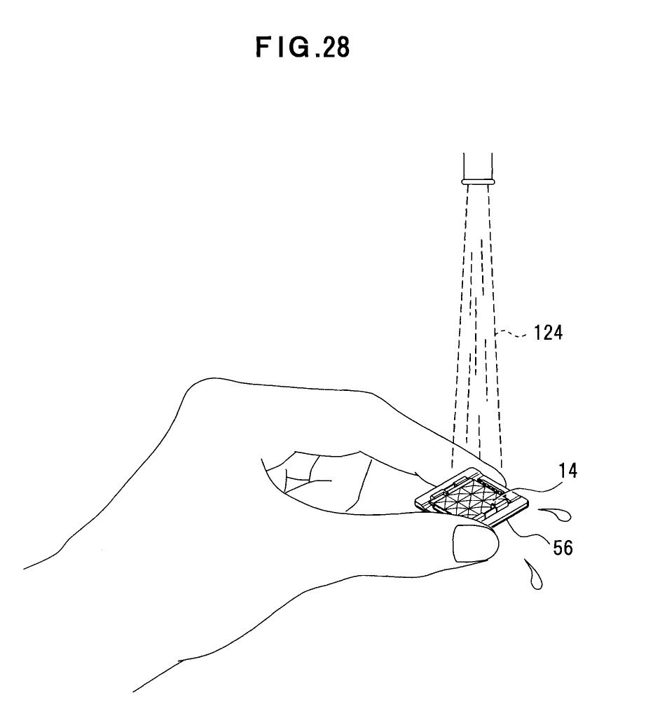

Exchange of the fragrance chip will now be described with reference to FIGS. 26, 27 and 28. FIG. 26 depicts exchange of the rear cover, FIG. 27 depicts washing of the chip, and FIG. 28 depicts washing of the chip on the cap. Each structure depicted in FIGS. 26 to 28 is an example, and thus the present invention is not limited to such structures.

In the cellular phone 32, a rear cover 400 where the chip 14 is not mounted is prepared for the rear cover 40 where the chip 14 is mounted. The rear cover 400 is the former cover member, and a structure thereof is the same as the rear cover 40 excluding that the rear cover 40 has the accommodating part 54 and the cap 56. According to such a structure, the rear cover 40 and the rear cover 400 are exchangeable in accordance with the preference of a user or a situation in a user as to the cellular phone 32, and both of the covers are usable selectively.

In the cellular phone 32, a different aroma is selectable by any of exchange with the rear cover 40 of the other fragrance 106, exchange with the cap 56 of the other fragrance 106 and exchange with the chip 14 of the other fragrance 106.

If the chip 14 is washed by tap water 124 as depicted in FIG. 27, the chip 14 can be impregnated with the fragrance 106 of a different aroma as depicted in FIG. 23 or 24. The chip 14 may be washed by the tap water 124 while the chip 14 is being held by the cap 56 as depicted in FIG. 28. Dedicated water may be used for washing the chip 14.

The features, advantages or modification of the above second embodiment will be listed.

(1) A portable device such as the cellular phone 32 including a fragrance function is to be realizable.

(2) Sprinkling the chip 14 with a fragrance (for example, a perfume) enables a portable device to be given an aroma of a preference.

(3) Since the chip 14 is impregnated with the fragrance 106, there is no need to load a dedicated aromatic or aromatic to a dedicated attachment, and an aroma is exchangeable without any restriction. When an aroma is exchanged, an aroma before the exchange is easily removable by washing. Thereby, the reliability of a device does not decrease.

(4) If a material of waterproof and fragrance (alcohol) resistance is selected for the battery cover 62 in addition to waterproof construction of the housing 34, impregnation of the housing 34 with the fragrance 106 can be prevented.

(5) If a porous chip material made by porous ceramics that is able to hold ingredients of the fragrance 106 for a long time is placed, the chip 14 is impregnated with the fragrance 106 by sprinkling the fragrance 106, and an aroma therefrom can be maintained.

(6) Marketed products are usable for the fragrance 106. Thus, an aroma which a user prefers is easily selectable and realizable.

(7) Since the chip 14 is placed on the back of the cap 56, the chip 14 is removable easily only by opening the cap 56. There is no inconvenience that a fragrance erroneously adheres to a device since the fragrance 106 is sprinkled with the cap 56 removed.

(8) While ABS resin is usable as to a material of corrosion resistance that surrounds the chip 14 impregnated with the fragrance 106, effects from a fragrance and alcohol is avoidable if a material of crystalline nylon or PP of larger corrosion resistance is adopted.

(9) Since the diffuser holes (aroma holes) 58 are provided for the cap 56, the fragrance 106 can be diffused from the diffuser holes 58, and thus, a sufficient fragrance effect can be exercised.

(10) Since the chip 14 is placed over the battery pack 42, the heat generated from the battery pack 42 is got acting on the chip 14 to be able to promote volatilization of the fragrance 106 much more. A heat generating component may be a component generating heat such as an LCD (Liquid Crystal Display) device except the battery pack 42.

(11) In the above cellular phone 32, waterproof capability is provided for the housing 34. In a portable device having such a waterproof function, the device can be prevented from being impregnated with the fragrance 106 by a waterproof effect if the chip 14 is placed outside a waterproof area. That is, a function of the device and the reliability thereof are not decreased.

### Third Embodiment

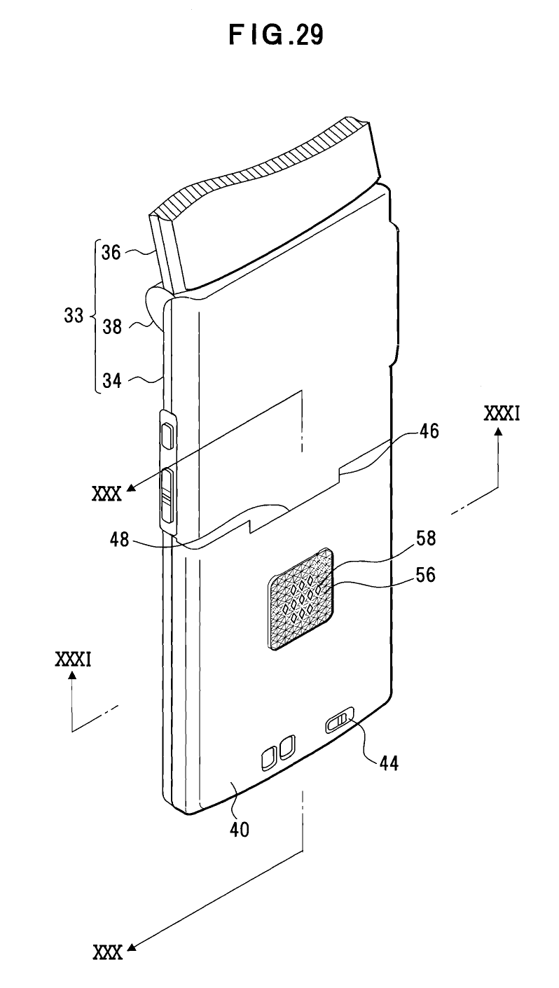

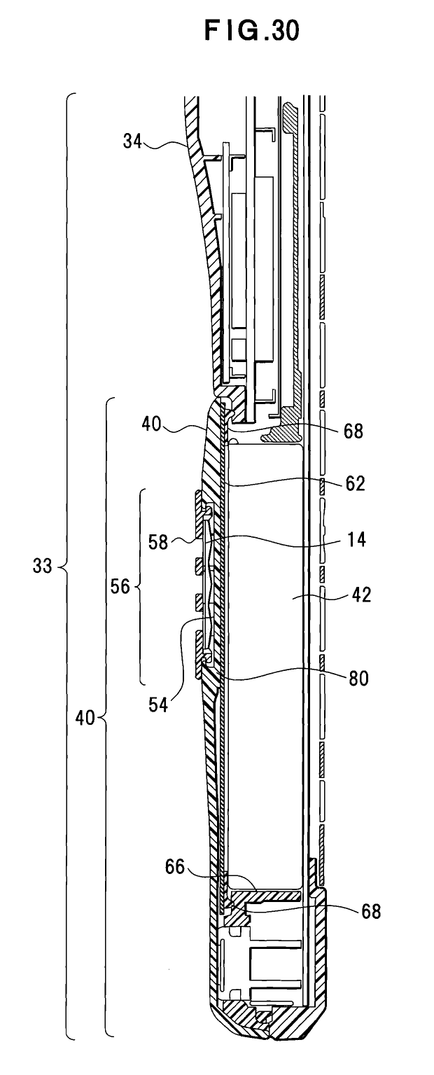

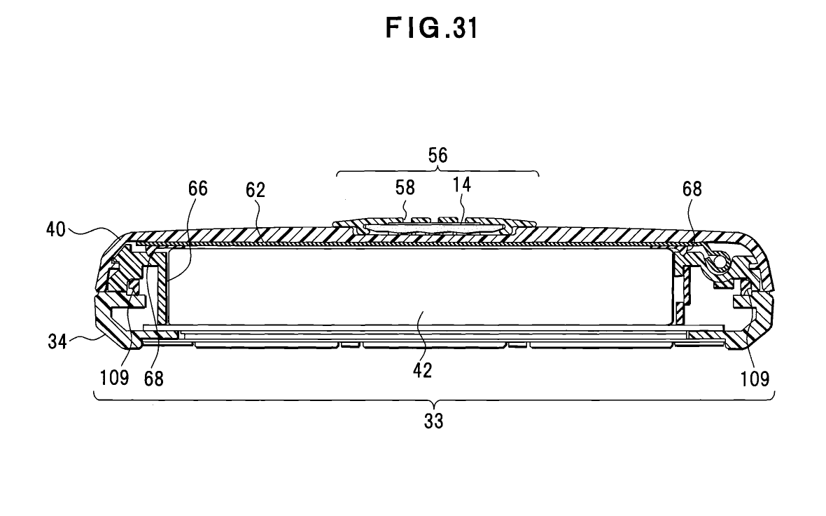

A third embodiment will now be described with reference to FIGS. 29, 30 and 31. FIG. 29 depicts a cellular phone viewed from its back according to a third embodiment, FIG. 30 is a sectional view of FIG. 29 along the line XXX-XXX, and FIG. 31 is a sectional view of FIG. 29 along the line XXXI-XXXI. Each structure depicted in FIGS. 29 to 31 is an example, and thus the present invention is not limited to such structures.

While the second embodiment is that the cap 56 may be placed inside the face of the rear cover 40, the third embodiment is that the cap 56 may project outside the face of the rear cover 40.

In a cellular phone 33, the cap 56 projects outside the face of the rear cover 40 as depicted in FIG. 29. In such a structure, the rear cover 40 can be placed so as to adhere to a housing 34 while the cap 56 projects outside the face of the rear cover 40 as depicted in FIGS. 30 and 31. Thus, the housing 34 including the rear cover 40 of the cellular phone 33 is able to achieve thinning down while the housing 34 is constructed as well as the second embodiment.

As the above, projecting the cap 56 eases attachment and detachment of the chip 14 along with the cap 56 from and to the rear cover 40. If the thickness of the edge around the cap 56 is thinned down like taper, extreme projection of the cap 56 from the rear cover 40 does not occur.

### Other Embodiments

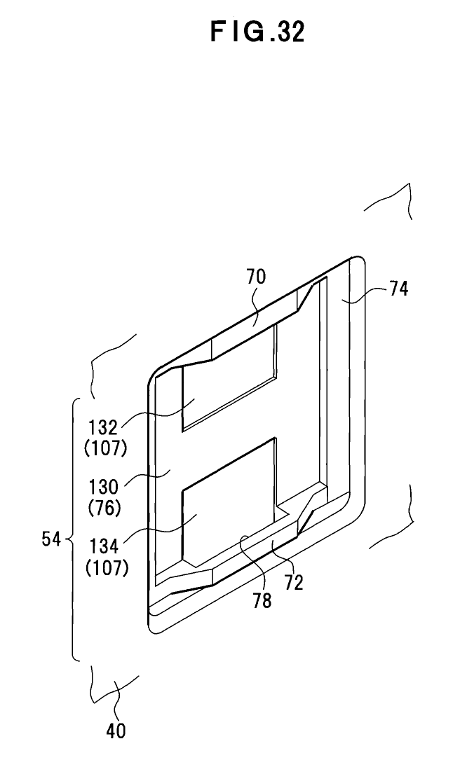

(1) In the second embodiment, the inner wall surface 76 of the accommodating part 54 is formed in a flat face. In the accommodating part 54, a wall 130 that has the same height as the inner wall surface 76 may be formed along with recesses 132 and 134 as depicted in FIG. 32. Providing such wall 130 enables the space 107 to be secured by the recesses 132 and 134 without weakening the strength of the accommodating part 54. Such space 107 by the recesses 132 and 134 multiplies the air touching the chip 14, prompts diffusion of an aroma from the chip 14 and thus, is able to contribute to promotion thereof.

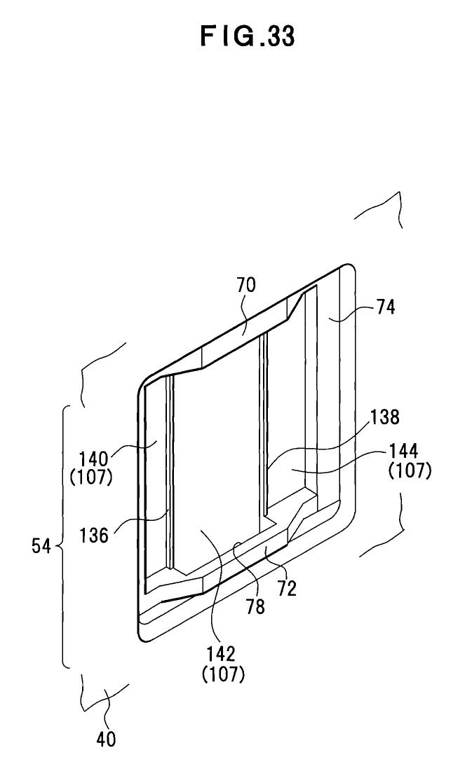

(2) Instead of the above described wall 130 and the recesses 132 and 134 (FIG. 32), ribs 136 and 138 may be formed across the accommodating part 54 as depicted in FIG. 33. Recesses 140, 142 and 144 may be formed by these ribs 136 and 138, and the above described space 107 may be secured. Each of the ribs 136 and 138 is a reinforcing wall that reinforces the accommodating part 54, and an example of a means securing the space 107. According to such a structure, the effect equivalent to the above described (1) can also be obtained.

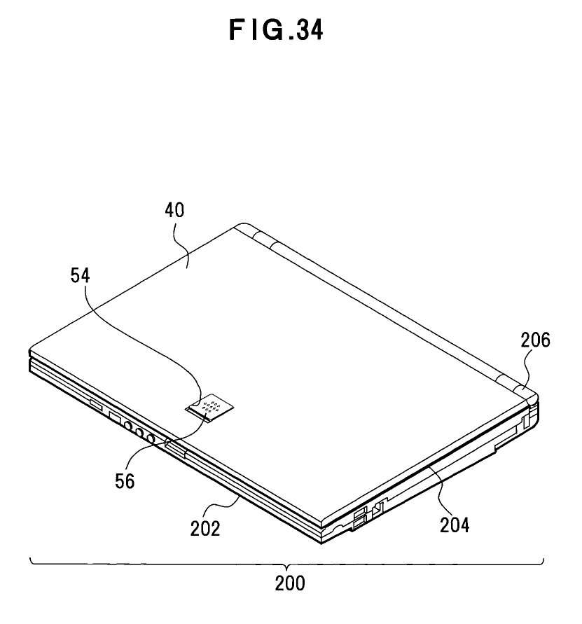

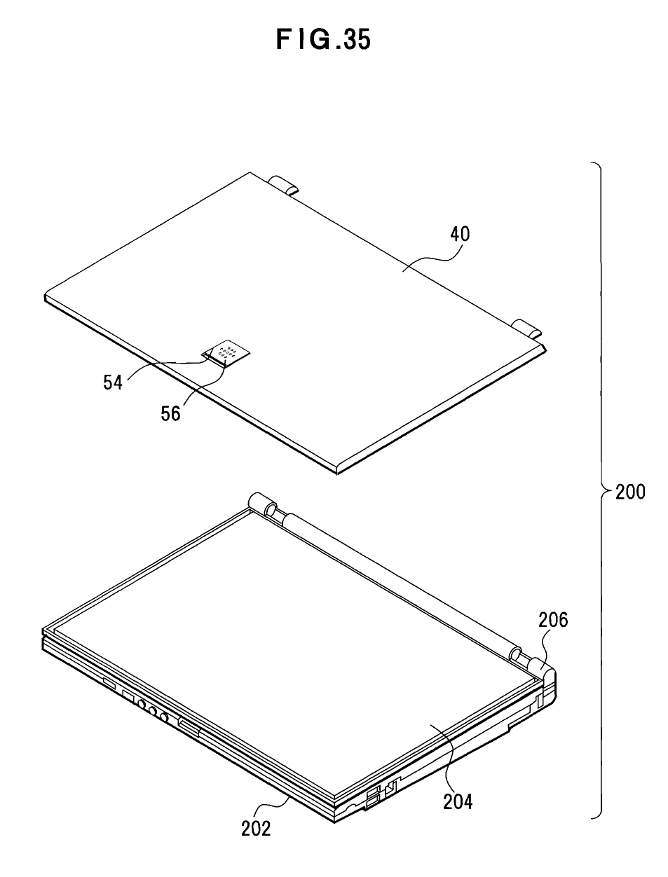

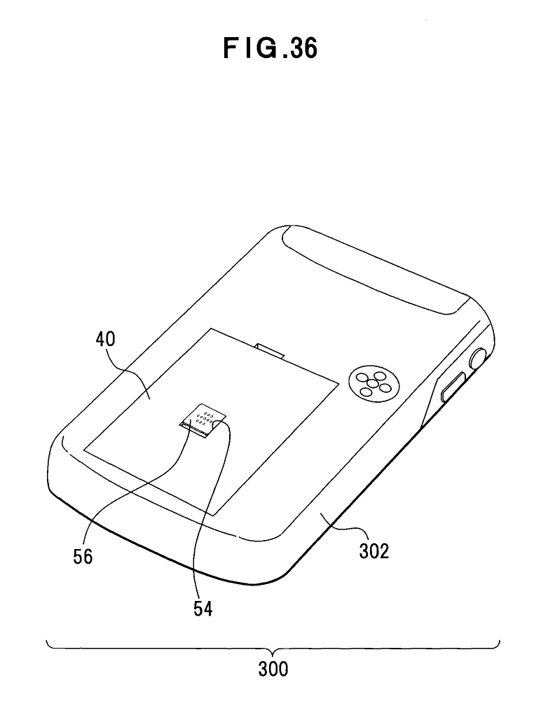

(3) In the above embodiments, the device 4 which the chip 14 is built in (FIG. 1), the cellular phone 32 including the chip 14 (FIGS. 2 to 28) and the cellular phone 33 (FIGS. 29, 30 and 31) are exemplified. The aroma diffuser of the present disclosure is not limited to the above described embodiments. Such a device which the chip 14 is built in may be an electronic device such as a personal computer (PC) 200 (FIGS. 34 and 35), a portable information terminal device (PDA: Personal Digital Assistant) 300 (FIG. 36), a digital camera and an electronic video game device.

(4) The PC 200 includes a housing of a keyboard 202 and a housing of a display 204 as depicted in FIG. 34. These housings 202 and 204 are linked by a hinge 206, and openable and closeable. The rear cover 40 is fixed to or placed attachably and detachably on the housing of a display 204. The above described accommodating part 54 and the cap 56 are provided for the rear cover 40. The chip 14 impregnated with a fragrance 106 is held by the cap 56. According to such a structure, an aroma that the fragrance 106 has can be diffused from the PC 200.

If the rear cover 40 of the PC 200 is attachable and detachable as depicted in FIG. 35, the fragrance 106 is selected by exchange with the rear cover 40, exchange with the cap 56, exchange with the chip 14 or exchange with the fragrance 106 to enable an aroma to be diffused.

(5) In the PDA 300, the rear cover 40 is placed attachably and detachably on the back of a housing 302 as depicted in FIG. 36. The above described accommodating part 54 and the cap 56 are provided for the rear cover 40. The chip 14 impregnated with the fragrance 106 is held by the cap 56. According to such a structure, an aroma that the fragrance 106 has can be diffused from the PDA 300.

In the PDA 300, the fragrance 106 is also selected by exchange with the rear cover 40, exchange with the cap 56, exchange with the chip 14 or exchange with the fragrance 106 to enable an aroma to be diffused.

(6) In a video game device, an additional effect such as dramatizing a video game is enabled by an aroma of a fragrance or exchange of the aroma.

(7) A cellular phone and so on are exemplified as carried portable devices. The aroma diffuser of the present disclosure is not limited to portable devices, and may apply to an intercom, remote control, etc.

(8) While the fragrance chip 14 is exemplified as an aromatic chip in the above embodiments, a deodorant chip may be used.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

Technical ideas extracted from the embodiments of the present invention described above will then be listed. The technical ideas of the present invention may be comprehended at various levels and variations ranging from higher to lower conceptions and the present invention is not limited to the following description.

An aroma diffuser includes a housing to include an accommodating part that accommodates at least an aromatic chip, and a lid to be attached to the housing detachably and to close the accommodating part. The aromatic chip is provided for the lid.

In the above aroma diffuser, preferably, the housing may have a cover, and the lid may be attached to the cover detachably.

The above aroma diffuser may preferably include a holding part to be provided for the lid and to hold the aromatic chip attachably and detachably.

In the above aroma diffuser, preferably a space may be provided between the lid and the aromatic chip.

In the above aroma diffuser, preferably the cover may be placed outside a waterproof construction member of the housing.

In the above aroma diffuser, preferably the accommodating part accommodating the aromatic chip may be arranged in the vicinity of a heat generating member that is built in the housing.

In the above aroma diffuser, preferably the aromatic chip may include a main chip body and an aromatic or deodorant with which the main chip body is impregnated.

In the above aroma diffuser, preferably the lid may have a single or a plurality of diffuser holes that diffuse (s) an aroma.

In the above aroma diffuser, preferably the lid may have an engaging part engaging with the accommodating part of the housing, and may be detachably attached by the engaging part.

In the above aroma diffuser, preferably a recess may be provided between an outer edge of the lid and an inner edge of the accommodating part. The gap 60 (FIG. 3) is an example thereof.

Following effects can be obtained according to the aroma diffuser of the present disclosure.

(1) A desired aroma can be diffused from a housing having an aromatic chip.

(2) An aroma is easily selectable by any of exchange of a lid including an aromatic chip, exchange of an aromatic chip on the lid or exchange of an aromatic of the aromatic chip.

While the embodiments of the aroma diffuser have been described hereinabove, the present invention is not limited to the above description, and it is a matter of course that various variations and modifications can be made by those skilled in the art based on the gist of the invention recited in the claims or disclosed in the embodiment, and needless to say, such variations and modifications are also encompassed in the scope of the present invention.

The aroma diffuser of the present disclosure is usable for an effect with an aroma, and is broadly used for a portable device such as a cellular phone and a fixed device. Thus, the aroma diffuser is useful.

What is claimed is:

1. An aroma diffuser comprising:
a housing to include an accommodating part that accommodates at least an aromatic chip; and
a lid to be attached to the housing detachably and to close the accommodating part,
wherein the aromatic chip is provided for the lid.

2. The aroma diffuser of claim 1, wherein the housing has a cover, and the lid is attached to the cover detachably.

3. The aroma diffuser of claim 1, further comprising a holding part to be provided for the lid and to hold the aromatic chip attachably and detachably.

4. The aroma diffuser of claim 1, wherein a space is provided between the lid and the aromatic chip.

5. The aroma diffuser of claim 2, wherein the cover is placed outside a waterproof construction member of the housing.

6. The aroma diffuser of claim 1, wherein the accommodating part accommodating the aromatic chip is arranged in the vicinity of a heat generating member that is built in the housing.

7. The aroma diffuser of claim 1, wherein the aromatic chip includes a main chip body and an aromatic or deodorant with which the main chip body is impregnated.

8. The aroma diffuser of claim 1, wherein the lid has a single or a plurality of diffuser holes that diffuse(s) an aroma.

9. The aroma diffuser of claim 1, wherein the lid has an engaging part engaging with the accommodating part of the housing, and is detachably attached by the engaging part.

10. The aroma diffuser of claim 1, wherein a recess is provided between an outer edge of the lid and an inner edge of the accommodating part.
